(19) United States
(12) Patent Application Publication
(10) Pub. No.: US 2003/0214401 A1
(43) Pub. Date: Nov. 20, 2003

(54) Multi-point security system

(76) Inventor: Lion Lee, Taipei Hsien (TW)

Correspondence Address: Alan D. Kamrath, Rider Bennett, LLP, Suite 2000, 333 South Seventh Street, Minneapolis, MN, 55402, US

(21) Appl. No.: 10/437,136

(22) Filed: May 13, 2003

(30) Foreign Application Priority Data
May 14, 2002 (TW) 091206841

(51) Int. Cl. G08B 19/00

(52) U.S. Cl. 340/531; 340/521; 348/152

(57) ABSTRACT

A multi-point security system employing network communication is provided. The system includes a main unit (10) being connected to a digital server (50), a video and audio recording unit (20) and a sensor and alarm unit (30), wherein the video and audio recording unit (20) and the sensor and alarm unit (30) are formed by a plurality of monitoring devices (21) and sensors (31), which simultaneously collect scanning data and feed the data back to the main unit (10) by wireless means. Multiple monitoring points can be set up in strategic locations for close surveillance of the site situation around-the-clock, and the scanning data can be accessed through a personal computer (60) or cellular phone (61) with a predetermined network or email address.

### BACKGROUND OF THE INVENTION

1. Field of the Invention

The present invention relates to a multi-point security system employing network communication, and in particular to a security system that is able to perform synchronous surveillance at multiple remote locations employing network communication.

2. Description of Related Arts

Most people use mechanical locks and anti-burglar electronic devices to protect homes and personal properties against burglars and thieves but with limited results. Some high-income families and business companies may seek the professional services of security companies, which regularly send out their men to check on the properties of clients. They may also install the necessary detectors and alarm devices in and around the premises of the clients to perform around-the-clock surveillance.

Business companies hire their own security guards to patrol their premises and properties to protect against burglars and thieves. These security personnel are able to offer on-site surveillance and fast response for any situations, but the overhead expenses are affordable by large companies only.

Home security by contract cannot offer clients real-time surveillance around the premises. If something happens, the security company will inform the client of the situation only after an event has occurred. For the clients, they cannot obtain the first-hand information about the situation around their homes and property and thus cannot take the necessary steps to control the situation in real time.

In times of rising social unrest and crime rates, there is a potential market out there for a type of monitoring device that employs network technology to transfer video and audio data to a remote location for real-time monitoring of the situation on site, and these devices should also be able to provide easy installation and data access through the Internet connection.

### SUMMARY OF THE INVENTION

The main object of the present invention is to provide a remote-controlled security system with a plurality of monitoring devices and sensors installed at different strategic locations for synchronous surveillance of site situation. These monitoring devices having audio and video recording capability are interconnected through a network for transferring video and audio data to a remote location for real-time monitoring by an owner user, thus effectively boosting the capability of home security.

The security system in accordance with the present invention comprises:

a main unit formed by a signal conversion circuit and a receiver circuit, wherein the signal conversion circuit is connected to the input of the receiver circuit, whilst the output of signal conversion circuit is linked to a digital server;

a video and audio recording unit, formed by a plurality of monitoring devices having video and audio recording capability and corresponding transmitter circuits, responsible for converting video and audio signals to RF signals and passing them to the main unit through the transmitter circuits; and

a sensor and alarm unit, containing a plurality of sensors possessing a specific sensing function, corresponding buzzer alarms and transmitter circuits, wherein each sensor and alarm can be installed at any location within the effective signal reception range of the main unit, such that video and audio signals can be transferred back to the main unit for signal processing.

The above-mentioned security system employs RF signal transmission between the main unit and outlying video and audio monitoring units and sensor and alarm units, and then the main unit is physically connected to the digital server for data transfer.

The video and audio recording units and the sensor and alarm units are distributed in several strategic locations around the site for detection of irregularities and transferring the video and audio data back to the main unit through radio transmission.

If the video and audio signals pick up an irregularity on the scan site, this information will be passed over the network from the digital server connected to the main unit to a remote location where the owner user can monitor the site situation.

At the same time that the owner user is alerted of the irregularity, an alarm will be triggered to scare off any intruders by warning them that the property owner is being put on an alert of the situation.

The owner user only has to log on to the Internet with a predetermined network address or an email address through a personal computer or a cellular phone to access the video and audio data on a real-time basis. The information will be continuously sent over the network to the remote location of the owner user for real-time monitoring of the site situation.

The secondary object of the present invention is to provide a concealed security system, such that the sensor and monitoring devices can be hidden away to prevent any sabotage by would-be intruders who might try to dismantle or damage the monitoring devices before performing any criminal act.

The third object of the invention is to provide real-time scan information that can be received by network computers or cellular phones, wherein the users of cellular phones can use coded messages to give instructions to the security system by wireless means.

The features and structure of the present invention will be more clearly understood when taken in conjunction with the accompanying drawings.

### BRIEF DESCRIPTION OF THE DRAWINGS

FIG. 1 is a block diagram of the overall structure of the invention;

FIG. 2 is partial diagram of the invention showing the architecture of the video and audio recording unit and the sensor and alarm unit;

FIG. 3 is a circuit diagram of the main unit;

FIG. 4 is a circuit diagram of the transmitter circuit; and

FIG. 5 is a circuit diagram of the AC/DC power circuit.

### DETAILED DESCRIPTION OF THE PREFERRED EMBODIMENT

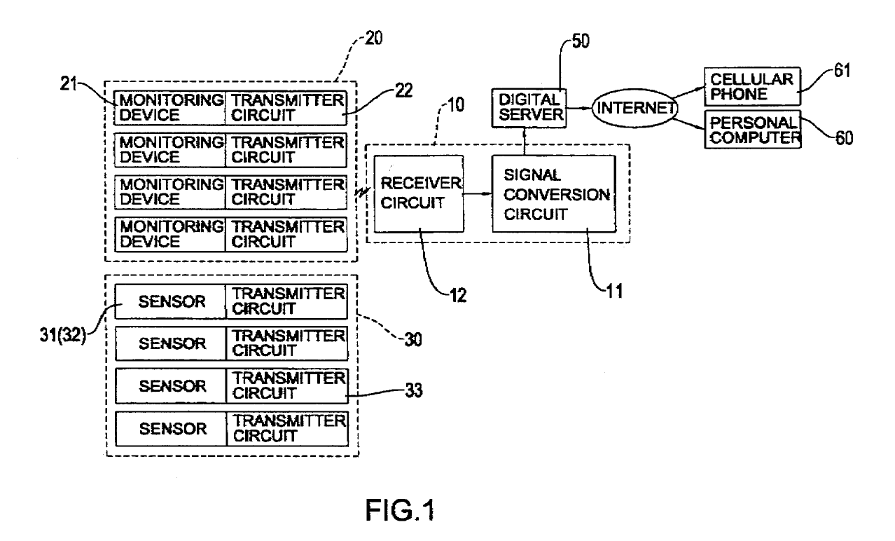

The present invention provides a multi-point security system with alarm warning function, as shown by the block diagram in FIG. 1, comprising:

a main unit (10) formed by a signal conversion circuit (11) and a receiver circuit (12), wherein the signal conversion circuit (11) is connected to the input of the receiver circuit (12), whilst the output of the signal conversion circuit (11) is linked to a digital server (50); wherein the digital server (50) is logged onto the Internet for data transfer to a remote location where the owner user may be using a personal computer (60) or cellular phone (61);

a video and audio recording unit (20), formed by a plurality of monitoring devices (21) having video and audio recording capability and corresponding transmitter circuits (22), wherein the video and audio output terminals of the monitoring device (21) are connected to the corresponding transmitter circuit (22) for converting the video and audio signals to RF signals before transmitting them to the main unit (10); and

a sensor and alarm unit (30), formed by a plurality of sensors (31) possessing a specific sensing function, corresponding buzzer alarms (32) and transmitter circuits (33), wherein each sensor (31) and buzzer alarm (32) can be installed at any strategic location around the scan site within the signal reception range of the main unit (10), such that video and audio signals can be normally collected and transmitted back to the main unit (10) for signal processing.

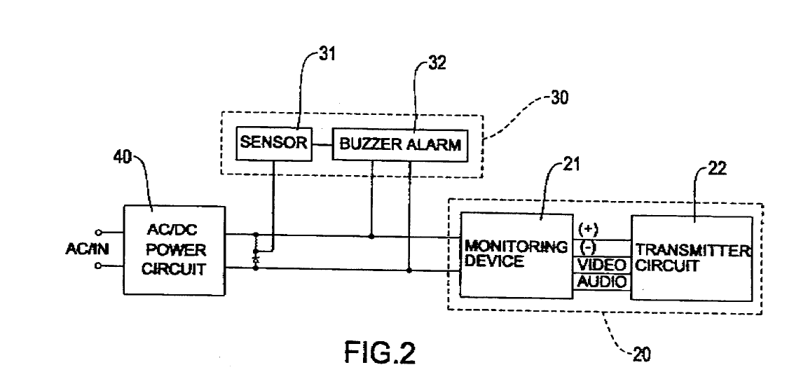

In FIG. 2, a combined circuit diagram of the video and audio recording unit (20) and the sensor and alarm unit (30) is shown. An AC/DC power circuit (40) is used to provide the necessary power for the sensors (31), buzzer alarms (32), monitoring devices (21) and transmitter circuits (22). An uninterruptible power supply can be optionally embedded to cope with any power breaks, such that the video and audio recording unit (20) and the sensor and alarm unit (30) can still function under the emergency conditions.

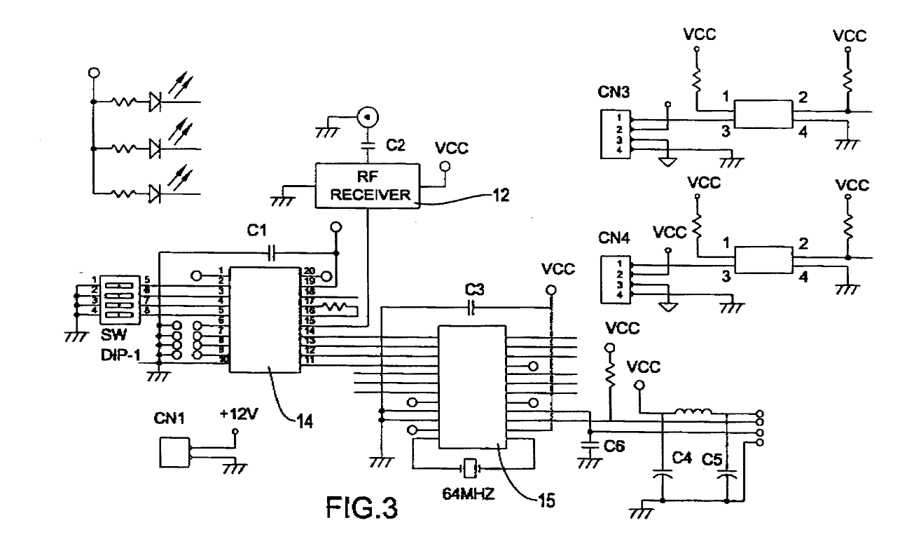

As shown in FIG. 3, the main unit (10) comprises a receiver circuit (12) and a signal conversion circuit (11), wherein the receiver circuit (12) collects the signals from the video and audio recording unit (20) and the sensor and alarm unit (30), and then decodes and converts the signals through a decoder (14) and a converter (15) to produce a digital signal format readable by a digital server (50). The converter (15) can be built with a digital IC supporting USB specification.

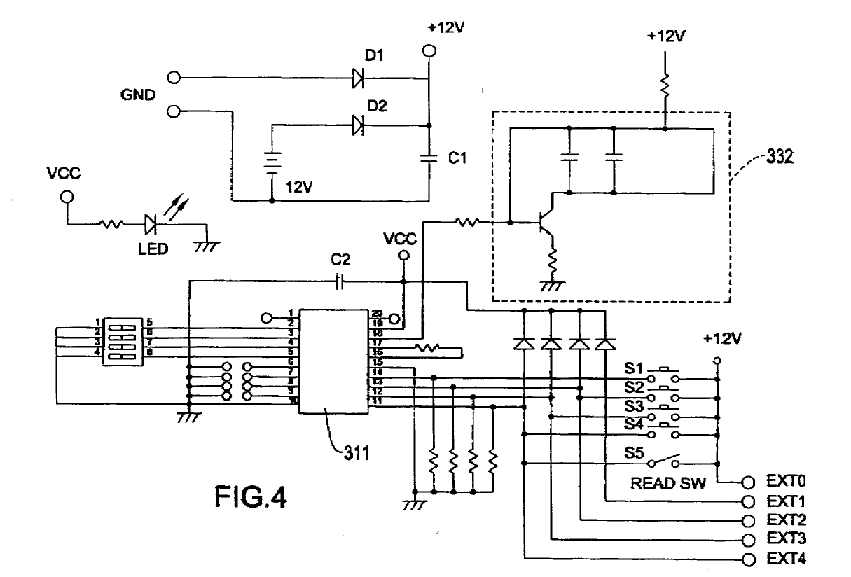

As shown in FIG. 4, the transmitter circuit (33) comprises an encoder (331) and an RF transmitter (332), wherein the input of encoder (331) is connected to the output of the sensor (30) passing on encoded signals to the transmitter circuit (332), which then transmits the signals to main unit (10) by wireless means.

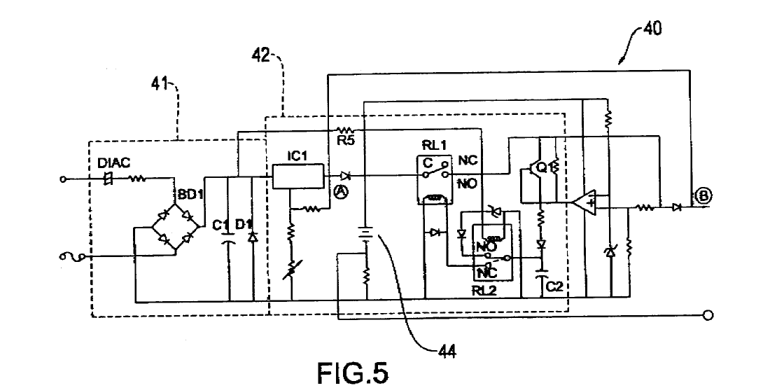

As shown in FIG. 5, the AC/DC power circuit (40) comprises:

a filtering circuit (41) formed by a DIAC, a full-bridge rectifier BD1, and a high voltage C1 for generating DC signals; and

a switching unit (42) formed by two relay switches RL1, RL2, a capacitor C2 and a transistor Q1, wherein RL1 and RL2 are connected across the output of the filtering circuit (41) and a battery (44) for switching output between these two.

The operation principles of the above-mentioned circuitry (41) are to be explained below. In the normal operating condition, the filtering circuit (41) provides a positive voltage through R5 to energize the excitation coil of the relay switch RL2, so that the switch is toggled from normal-closed to normal-open position, and the grounded capacitor C2 connected in series to RL2 will be energized. However, when the AC power is cut off, RL2 is toggled to the normal-closed position. Since the excitation coil of RL1 in the DC circuit is connected in series to the normal-closed terminal of RL2, the transistor will provide continuous current to the capacitor C2, which is drained to ground through the excitation coil of RL2, so the excitation coil of RL1 connected in series will be energized to switch RL1 to the normal-open position, and then the battery (44) begins to provide DC output through B terminal.

From the foregoing, it is clear that the present invention possesses a number of advantages over conventional models, in that:

High security: the monitoring devices and sensors can be set up at appropriate locations around the scan site for close surveillance;

Simple installation: using radio communication between the sensors, monitoring devices and remote receiver, without any wiring;

Highly concealed: using wireless means and leaving no wire traces for any possible sabotage by intruders who may try to dismantle the security devices before any criminal act; High mobility: the main unit is connected to the Internet through a digital server, such that the owner user can access the video and audio data using a cellular phone to give instructions with coded messages; and

Alarm function: the sensor and alarm unit is able to issue audible warning to scare off intruders when any irregularity is detected.

The foregoing description of the preferred embodiments of the present invention is intended to be illustrative only and, under no circumstances, should the scope of the present invention be so restricted.

What is claimed is:

1. A multi-point security system employing network communication comprising:
a main unit (10) formed by a signal conversion circuit (11) and a receiver circuit (12), wherein the signal conversion circuit (11) is connected to the input of the receiver circuit (12), whilst the output of the signal conversion circuit (12) is linked to a digital server (50);
a video and audio recording unit (20), formed by a plurality of monitoring devices (21) having video and audio recording capability and corresponding transmitter circuits (22), for converting the video and audio signals to RF signals before sending them to the main unit (10); and
a sensor and alarm unit (30), formed by a plurality of sensors (31) possessing a specific sensing function, corresponding buzzer alarms (32) and transmitter circuits (33), where each sensor (31) and alarm (32) can be installed at any location within the signal reception range of the main unit (10), such that video and audio signals can be transferred back to the main unit (10) for signal processing;
wherein the main unit (10) connected to a digital server (50) is able to process video and audio signals from the video and audio recording unit (20) and the sensor and alarm unit (30) to pick out any irregularity on the scan site, and then to transmit the scanning data to a remote personal computer or cellular phone controlled by an owner user through an Internet connection.

2. The multi-point security system employing network communication as claimed in claim 1, wherein the main unit (10) comprises:
a receiver circuit (12) for receiving RF signals carrying scan data;
a decoder (14) being connected to the output of the receiver circuit (12) for decoding the received video and audio signals from the receiver circuit (12); and
a converter (15) being connected to the output of the decoder (14) for converting the decoded signal to a standard format readable by the digital server (50).

3. The multi-point security system employing network communication as claimed in claim 2, wherein the converter (15) can be built with an IC supporting USB specifications.

4. The multi-point security system employing network communication as claimed in claim 2, wherein the security system further includes an AC/DC power circuit.

5. The multi-point security system employing network communication as claimed in claim 3, wherein security system further includes an AC/DC power circuit (40).

6. The multi-point security system employing network communication as claimed in claim 4, wherein the AC/DC power circuit (40) includes:
a filtering circuit (41) having a low voltage output; and
a switching circuit (42) being installed in between the output of filtering circuit (41) and the battery (44), such that when AC input is terminated, the DC circuit is ready to provide DC power.

7. The multi-point security system employing network communication as claimed in claim 5, wherein the AC/DC power circuit (40) includes:
a filtering circuit (41) having a low voltage output; and
a switching circuit (42) being installed in between the output of filtering circuit (41) and a battery (44), such that when AC input is terminated, the DC circuit is ready to provide DC power.

8. The multi-point security system employing network communication as claimed in claim 1, wherein the transmitter circuit (32) is formed by an encoder (331) and an RF transmitter (332).
